(19) United States
(12) Patent Application Publication
(10) Pub. No.: US 2017/0186223 A1
(43) Pub. Date: Jun. 29, 2017

(54) Detection of shadow regions in image depth data caused by multiple image sensors

(71) Applicant: INTEL CORPORATION, SANTA CLARA, CA (US)

(72) Inventor: ALON LERNER, Holon (IL)

(73) Assignee: INTEL CORPORATION, SANTA CLARA, CA (US)

(21) Appl. No.: 14/998,548

(22) Filed: Dec. 23, 2015

(51) Int. Cl. G06T 15/60; G06T 7/00

(52) U.S. Cl. CPC G06T 15/60; G06T 7/0053; G06T 7/0085

(57) ABSTRACT

Shadow regions in image depth data that are caused by multiple image sensors are detected. In one example a region of a row of pixel depth data in a row of pixels from a depth image is identified. A first valid pixel on a first side of the identified region is un-projected into a three-dimensional space to determine first point P1. A first vector is determined from the position C2 of the second camera to the first point. A second valid pixel on a second side of the identified region is un-projected into a three-dimensional space to determine second point P2. A second vector is determined from the position C2 of the second camera to the second point. An angle is determined between the first vector and the second vector and compared to a threshold. The missing region is classified as a shadow region if the angle is less than the threshold.

### FIELD

The present description relates to depth images using multiple camera positions and in particular to detecting shadows in a depth image.

### BACKGROUND

Many computer imaging, input, and control systems are being developed for depth images. Different computer and imaging systems use different camera systems to obtain the depth information. One such camera system uses two or more cameras physically spaced apart and compares simultaneous images to determine a distance from the cameras to the objects in the scene. Other camera systems use a rangefinder or proximity sensor either for particular points in the image or for the whole image such as a time-of-flight camera. A camera system with multiple sensors determines, not only the appearance of an object, but also the distance to different objects in a scene.

Depth images may have some pixels that have no valid depth data. Some pixels might lie in a shadow region. A shadow region is a portion of the image that is visible from one camera (e.g. a depth camera or an infrared camera) but not from the other camera (e.g. a second camera or an infrared projector). Since the depth data uses both cameras, the portion of the image that is not visible to the second camera does not have any depth data. Since the cameras, or camera and projector are located a short distance apart from each other there is a disparity in the view of each camera. The disparity between the cameras leads to scenarios where some objects are visible from one camera but are occluded, blocked, or hidden from the other.

Many image analysis techniques use edge detection. These include most depth-based tracking, object recognition and scene understanding systems, to name a few. Since shadows often fall beside edges of objects, when the depth data is missing or not reliable, edge detection is affected as ghost edges, for example edges between valid and missing data are incorrectly detected. In order to aid in correcting edge detections, the pixels with missing depth data are classified to determine whether the pixel falls within a shadow region. The missing depth data can then be estimated or corrected using other pixels that are not in the shadow region.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a linear diagram of portion of a row of pixels with missing depth data according to an embodiment.

FIG. 2 is a diagram of a camera plane and an imaged scene with two objects according to an embodiment.

FIG. 3 is a diagram of a scene with objects at different distances according to an embodiment.

FIG. 4 is a diagram of missing pixel depth data for the scene of FIG. 3 according to an embodiment.

FIG. 5 is a diagram of the missing pixel depth data for the scene of FIG. 3 in which the depth data is classified according to an embodiment.

FIG. 6 is process flow diagram of classifying missing depth data pixels according to an embodiment.

FIG. 7 is a diagram of a scene in which a shadow region has two discontinuous sections and of a portion of a row of the corresponding pixels according to an embodiment.

FIG. 8 is a diagram of a scene with three cameras in which a shadow region has two discontinuous sections and of a portion of a row of the corresponding pixels according to an embodiment.

FIG. 9 is an isometric diagram of a computing system for capturing depth images with shadow regions according to an embodiment.

FIG. 10 is an isometric diagram of an alternative computing system for capturing depth images with shadow regions according to an embodiment.

FIG. 11 is a block diagram of a computing device incorporating a depth sensing camera and shadow detection according to an embodiment.

### DETAILED DESCRIPTION

As described herein, shadow regions are reliably classified. The classifications may be applied to various other image analysis techniques such as edge detection for assessing the quality and validity of the depth data. The edge detection may then be applied to other image analysis systems. The shadow region classification may be done in 3D space rather than 2D for a simpler, more intuitive, and efficient approach. Rather than simply extrapolating missing data from neighboring pixels, the classification scheme allows the data to be filled in only in the shadow regions. It also allows the data to be filled in using only the background pixels.

Missing data in a depth image is classified as to whether or not it belongs to a shadow region. Stereo depth sensing technologies use two cameras, or a camera and a projector, located a short distance apart from each other in order to reconstruct a depth image. The cameras are located at 3D positions that will be identified here as C1 for the first camera and C2 for the second camera or the projector. The disparity between the positions of the two cameras leads to scenarios where some objects are visible from one camera but are occluded from the other. The pixels that are not visible are identified as belonging to the shadow region.

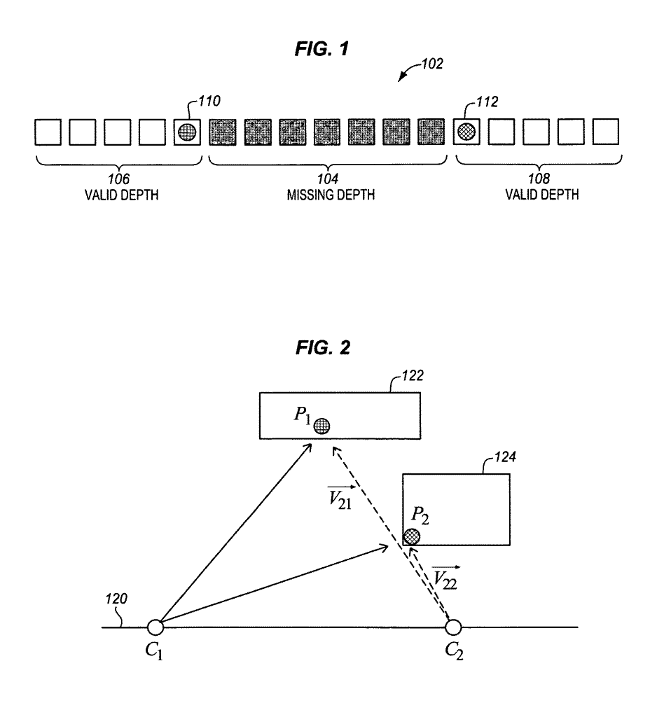

FIG. 1 is a linear diagram of depth data for pixels with different data. It is a graphical representation of the depth data for a portion of a row of pixels. The depth data has been determined by analyzing the disparity from the data from two different spatially separated positions C1, C2. The final image may have RGB, YUV, or some other color space information for each pixel in addition to the depth data, however, only the depth data is shown here.

In this portion 102 of a single row of a depth image, there is an area of missing data 104. On the left side of the missing data there is an area of valid depth data 106. There is another area of valid data 108 on the right side of the missing data. In any actual row there may be several sections with missing depth data and there may also be depth data missing from other rows. Scanning from left to right, the last valid pixel 110 before the missing data is marked and the first valid pixel 112 after the missing data is also marked. These pixels show two different styles of cross-hatching to identify and distinguish these two boundary pixels in this row.

Having identified the two last valid pixels 110, 112 on either side of the missing date region, these pixels are un-projected from the depth image into the original 3D space as shown in FIG. 2. This operation provides a point for each of the two last valid pixels identified as P1 and P2. The cross-hatching from the pixel row has been applied to these two points to show that P1 is the un-projected image point from the left side pixel 110 and P2 is the un-projected image point from the right side pixel.

FIG. 2 is a diagram of a camera plane and an imaged scene with two objects. The camera plane 120 is aligned with the image plane for the two cameras and is shown as being straight with respect to distance to objects in the scene. The z-direction or up in the drawing figure is the direction perpendicular or normal to the image plane and is one component of the distance from a camera to an object. The other components are the x and y translation. The x translation corresponds to left and right in the drawing and the y translation corresponds to position in and out of the page. The camera positions are simplified as point locations C1, C2. The scene is in front of the two cameras and in this example contains two objects 122, 124. The first un-projected point P1 is on the first object 122 and the second un-projected point P2 is on the second object 124. The diagram shows that in this example the two cameras are in positions that allow them to see both points. However, any point to the right of P1 on the first object will be obscured by the second object from the point of view of the second camera. Note also that the depth, or distance from the image plane, of P2 is very different from the depth of P1.

In this example, the camera at C1 is used for a primary image and the camera at C2 is only used to add depth information. Accordingly, all pixels in the depth image are visible from C1. When depth data is missing or invalid, it is because the camera at C2 could not see the same pixels. The position of C2 can also be defined based on an offset from C1. Using the known positions of the cameras, two 3D vectors may be determined. The first vector V21 is defined as the normalized direction vector between C2 and P1. The second vector V22 is defined as the normalized direction vector between C2 and P2. The dot product (d) between the two vectors can be used to find the cosine of the angle θ between them.

The vector determinations may be made as in the following equations 1 and 2. The dot product (d) from equation 3 may be used to determine that the corresponding area is a depth shadow where d<cos(θ). Using the inverse cosine, the angle θ can be determined from the dot product as in equation 4.

$$\begin{matrix}\vec{{V}_{21}} = \frac{{C}_{2} - {P}_{1}}{‖ {C}_{2} - {P}_{1} ‖} & Eq . 1 \\ \vec{{V}_{22}} = \frac{{C}_{2} - {P}_{2}}{‖ {C}_{2} - {P}_{2} ‖} & Eq . 2 \\ d - \vec{{V}_{21}} \cdot \vec{{V}_{22}} & Eq . 3 \\ θ = {cos}^{- 1} d & Eq . 4\end{matrix}$$

The value of the angle θ may be used to classify the missing data 104 in the row of pixels. If the angle is small, then the missing data lies in a shadow region. From the point-of-view of a camera at C2, the points P1 and P2 should be projected to adjacent pixels. If the angle is large, then the missing data is not part of a shadow region. If there are more rows, then the approach can be extended.

In this example, the first camera is the reference camera and the second camera is used to determine the angles. This approach may be applied to systems with more cameras by selecting one camera as the reference camera and the camera angles from all of the other cameras are defined with respect to the reference camera. If there is one camera that is used to form a 2D image to which depth data is added, then that camera may be selected to be the reference camera. This approach may also be easily extended to rectified or aligned depth data, i.e. depth data that has been projected onto a third camera (e.g. an RGB camera).

As a further test, the shadow classifications for other rows may be compared to the current row. Shadows that are caused by real objects should be consistent across rows. Shadows may be considered to be consistent when shadow pixels are contiguous and changes are gradual. Since real objects have contiguous shapes, the shadows of these objects should, for the most part, also be contiguous. Adjacent rows in the depth image should have similar shadows. If the shadows are not consistent then the depth data surrounding the suspected shadows are not caused by shadows and will be noisy and incorrect. The described approach is simple and efficient.

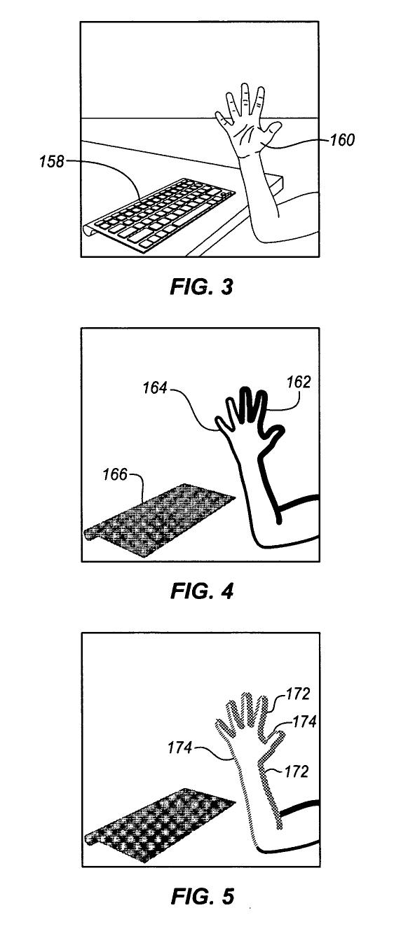

FIG. 3 is a diagram of a scene that might be captured by a depth camera. The camera may be providing input to a command system, to a gaming device, for a video conference node, or as a still or video camera to capture photographs or video of the scene. The scene has a keyboard 158 on a desk, and a user's forearm and hand 160 are raised over the desk. These scene objects are provided as examples to illustrate different types of missing depth regions and the benefits of classification. The techniques described above may be applied to many different types of objects in many different types of scenes.

FIG. 4 is a diagram of the same scene to show locations or pixels in which some depth data is missing or invalid. Missing data is indicated by black areas. Full data is indicated by the white areas. In this example, the body of the keyboard 166 is not reflective and has low contrast so that the depth data is missing or invalid. The outline of the forearm and hand 162, 164 are also missing depth data.

FIG. 5 is a diagram of the same depth pixel data as in FIG. 4 indicating how pixels with missing depth data are classified after applying the classification techniques described above. The pixels on the right side of the foreground object 172 of the scene are indicated with a first style of cross-hatching. These correspond to a first shadow region. The pixels with the second cross-hatching style are marked as shadows on the left side of the foreground object 174. These are a different shadow region. Note that the missing depth data of the keyboard were not classified as shadows. The depth data is missing for the keyboard because the system was not able to capture depth data because it was not able to find a reliable correspondence between the pixels on the solid black keyboard. The problem was not a shadow as described here. If depth data is to be recovered for the keyboard, then a different approach will be used than for the shadow areas.

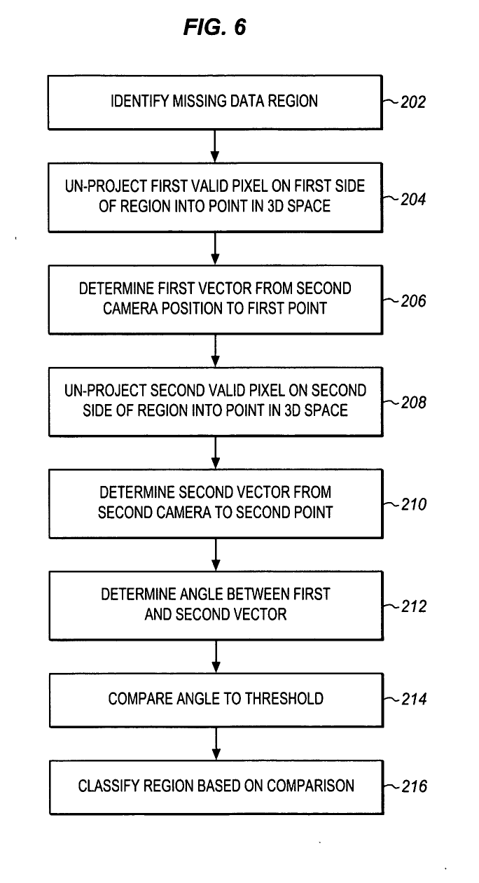

The process for classifying a missing region of data as described above may be summarized as shown in the process flow diagram of FIG. 6. As described above, a missing region of data in a row of pixels from a depth image is identified. The depth image is from a camera located at a 3D position C1 and a second camera located at a 3D position C2. The missing data is classified as being part of a shadow region of the second camera.

At 202 a region of the row of pixels is identified as missing depth data. The valid pixels on either side of the missing region are considered. The valid pixel to the left of the region is taken and un-projected at 204 from a pixel in a row of image pixels to 3D space. This provides point P1. At 206 a first 3D vector V21 is determined as the normalized direction vector between C2 and P1.

At 208 the valid pixel to the right of the region is taken and un-projected from the pixel row to a point P2 in the same 3D space. Using this point, a second vector V22 is determined at 210 as the normalized direction vector between C2 and P2. These two vectors may then be used to obtain some representation at 212 of the angle between the two points P1 and P2 from the perspective of the second camera at C2. If the angle is small, then at 214, the region between the two points may be classified at 216 as being in a shadow or obscured from the view of the second camera. If the angle is large, then at 214, the region is classified as not being in a shadow. There is a different reason that the depth data is missing.

There are many different representations of the angle between the vectors. The dot product between the vectors may be used directly. The dot product may also be used to determine the actual angle using an inverse cosine or other function. Other functions may also be applied to the dot product to produce more suitable values. The predefined threshold may be pre-determined, set empirically, or re-determined for each image or a series of related images. The threshold can be extracted from the input data by performing the above vector and dot product computations for multiple different cases of two valid adjacent pixels.

The techniques described above begin with a region in which the depth data is missing or invalid. In order to perform the various described operations, the regions of missing data are first identified.

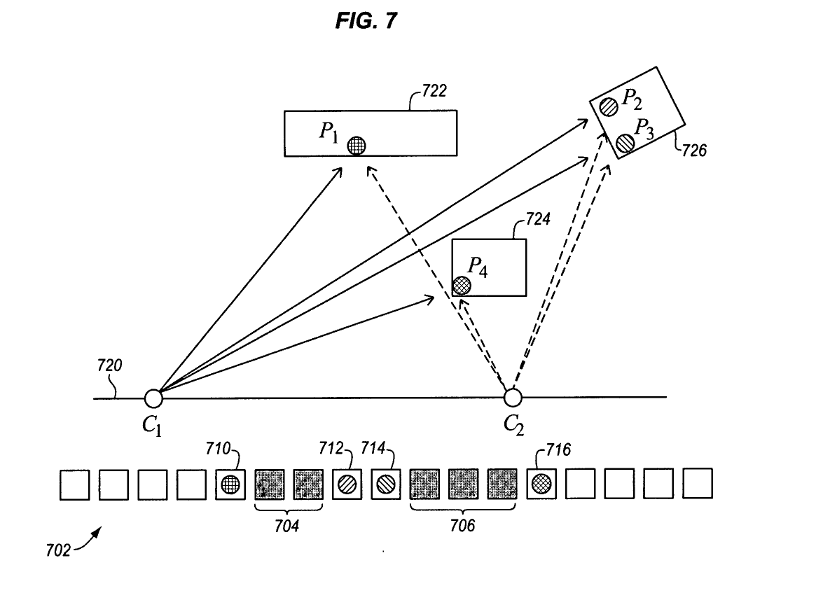

Regions of missing depth data may be defined as one or more consecutive or adjacent pixels with no depth data or with invalid depth data. A shadow region is most often a single region of missing data. However, in some cases the shadow region may include several disjoint or separated missing regions. FIG. 7 is a diagram of a scene in which there are three objects and the three objects cause a discontinuity between the missing regions of the depth data. The scene shows a scenario where a shadow region has two separate discontinuous sections. A portion of a continuous row 702 of pixels has two missing depth data regions 704, 706 with valid depth data in pixels 712, 714 between the missing data regions. Such a situation may be caused by many different object configurations in a scene. The number of missing pixels between regions and the sizes of the regions is provided only as a simplified example. With hundreds or thousands of pixels in each row, the missing regions and intermediate regions may be much larger.

In this example, there are two cameras aligned along a camera and image plane 720 at positions C1, C2 that are spatially separated from each other. As in FIG. 2, the first camera on the left at position C1 is used for the image data, such as RGB, YUV or similar color data. The second camera on the right at position C2 is used for depth data. This camera may alternatively be a projector or other depth device. The signal from the projector is received at the first camera but the projector beam can only image scene or object features that are visible from the perspective of the projector's position at C2 on the camera plane. The first camera has a clear unobstructed view of three objects 722, 724, 726. The second camera at C2 has a different view.

Using the principles described above, the valid pixels on either side of the missing data regions are identified. There is a pixel at the left 710 and the right 712 of the first missing data region 704. There is a pixel at the left 714 and the right 716 of the second missing data region 706. Each of these is identified with a unique style of cross-hatching. The pixels on either side of each region are un-projected into the 3D space to yield two positions for each region labeled as P1, P2, P3, and P4. The cross-hatching shows that the left most pixel 710 is un-projected to form P1. Similarly, the pixel 712 on the left side of the first region 704 corresponds to point P2. The left side pixel 714 relative to the missing data region 706 corresponds to P3 and the right side pixel 716 corresponds to P4. Vectors are then determined from the second camera position C2 to each of the four points and the angle between vectors to outside points is determined.

From the point-of-view of the first camera, the positions are ordered P1, P2, P3, and P4. However from the point-of-view of the second camera at C2, the positions are ordered P1, P4, P2, and P3. The change of order splits the shadow region 704, 706 in two.

In order to accommodate such split regions, the system can first try to classify the shadow region as a single missing region. If that fails (i.e. not classified as a shadow region because the angle is too large or larger than a threshold), then the system can try to classify neighboring regions together (in this example, classifying the regions together would be trying to classify all of the pixels between the outer pixels 710, 716 in the row corresponding to un-projected point P1 and P4.

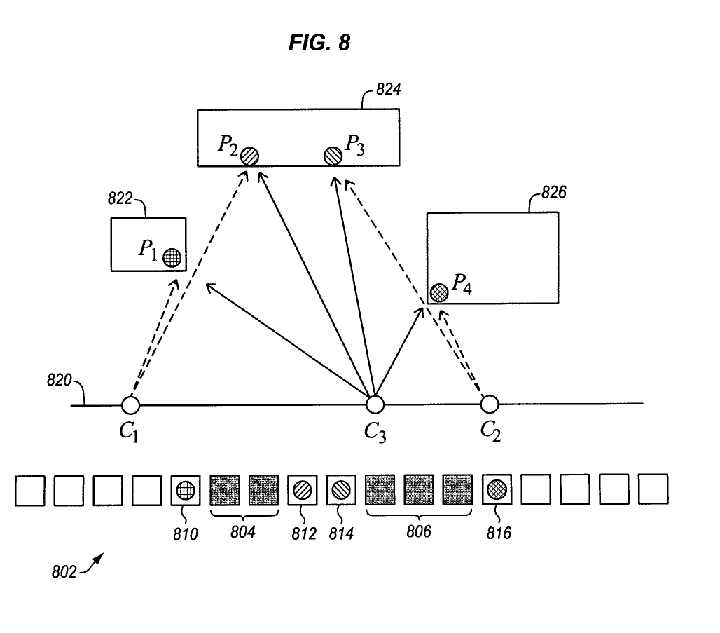

A three camera system may also be accommodated using the techniques described herein. FIG. 8 shows a three camera system in which three cameras are positioned on an image plane 820 at spatially separated positions C1, C3, C2. In this example, the center camera is a higher resolution camera for capturing color images. The other two cameras C1, C2 are for capturing depth information to be combined with the higher resolution image. In other words, the depth data is projected onto the new camera, which may be called the RGB camera. The other cameras may be infrared, monochrome, or another type sufficient for determining depth.

As in the example of FIG. 7, there are two regions 804, 806 for which depth data is missing in a portion of a row of pixels of an image 802. There is a pixel in the row to the left 810 and to the right 812 of the first region 804 and a pixel to the left 814 and to the right 816 of the second region 806. These have been un-projected into 3D image space and correspond to points P1, P2, P3, and P4, respectively, on objects in the actual 3D scene imaged by the cameras. This correspondence is shown using different style of cross-hatching to link the pixels with the points. In this example, there are three objects 822, 824, and 826. P1 is on the first object 822. The second two points P2, P3 are on the second object 824, and the fourth point P4 is on the third object 826.

If the new camera is located between the two original cameras and the order from left to right is C1, C3, and C2, then shadows on the left side of an object (i.e. shadows where the left point P1 is further from the camera than the right point P2) may be computed using the new camera and the one on its left side (i.e. C3 and C1). Shadows on the right side (i.e. shadows where the left point P1 is closer to the camera than the right point P2) may be computed using the new camera and the one on its right side (i.e. C3 and C2).

As an example, the left side missing segment 804 between the left side pixels 810, 812 corresponding to P1 and P2 is computed using C3 and C1. The right side segment 806 between the right side boundary pixels 814, 816 corresponding to P3 and P4 may be computed using C3 and C2. The determinations are done as described in detail above using vectors drawn from the camera positions to the points in 3D space on either side of the missing data regions and then determining the angle between the vectors to classify the regions 804, 806 between these points as either shadows or not shadows.

If the new camera position, C3, is not located between the other two camera positions C1, C2, then this example breaks down to the same two camera scenario as in the previous examples. The determination may in such a case be done using only C3 and C2.

Alignment shadows may sometimes occur due to rasterization. Alignment shadows show up as thin shadow-like regions on the opposite side of the object from an actual shadow region. As an example, if the second camera is located to the right of the first camera there might be shadow-like regions on the right side of the object. For alignment shadows, the two camera positions C1 and C2 may be set to be at origin points (0,0,0). With this adjustment, the same un-project, vector determination, and angle comparison approach may be used as described above.

The techniques above may be described in a general sense in a pseudo code as provided below. In this example there are up to three camera positions, a central depth camera at Cdepth, similar to the camera at position C3 in FIG. 8. There is also a camera potentially at either side of the central depth camera. These correspond to C1 and C2 above but are labeled here as Cleft and Cright. Accordingly, the pseudo code example uses a depth image and three camera positions.

Cleft - camera on the left side of Cdepth. If it doesn't exist set position to
(0,0,0).
Cdepth - depth camera, position set to (0,0,0).
Cright - camera on the right side of Cdepth. If it doesn't exist set position
to (0,0,0).
Loop across rows:
Loop across columns (scanline):

Get missing regions start/end point

Loop across missing regions (i:0 to num of region in row):

```
Loop back across missing regions (j:i to 0)
  P1=unproject start point jleft
  P2=unproject end point iright
  if P1<P2 (P1 is closer to the camera)
```

cls=classify (Cdepth,Cleft,P1,P2)

else

cls=classify (Cdepth,Cright,P1,P2)

if cls is in shadow

mark and break loop (j)

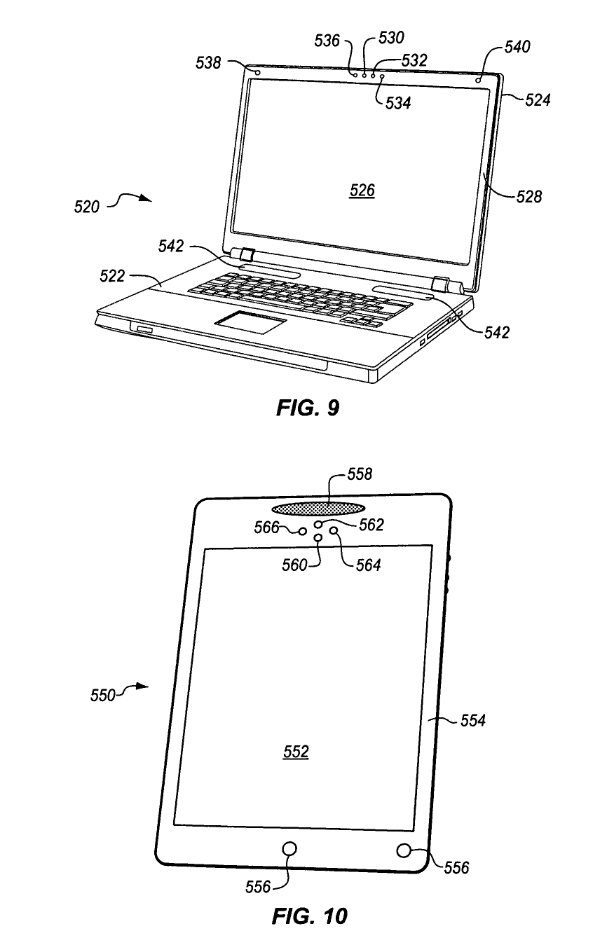

FIG. 9 is an isometric diagram of a portable device suitable for use with the depth camera shadow classification system as described herein. This device is a notebook, convertible, or tablet computer 520 with attached keyboard. The device has a display section 524 with a display 526 and a bezel 528 surrounding the display. The display section is attached to a base 522 with a keyboard and speakers 542. The bezel is used as a location to mount two or three cameras 530, 532 for capturing depth enhanced video images for authentication, gestures, and other purposes. The bezel may also be used to house a flash 534, a white flash or lamp 536 and one or more microphones 538, 540. In this example the microphones are separated apart to provide a spatial character to the received audio. More or fewer microphones may be used depending on the desired cost and audio performance. The ISP, graphics processor, CPU and other components are typically housed in the base 522 but may be housed in the display section, depending on the particular implementation.

This computer may be used as a conferencing or gaming device in which remote audio is played back through the speakers 542 and remote video is presented on the display 526. The computer receives local audio at the microphones 538, 540 and local video at the two composite cameras 530, 532. The white LED 536 may be used to illuminate the local user for the benefit of the remote viewer. The white LED may also be used as a flash for still imagery. The second LED 534 may be used to provide color balanced illumination or there may be an IR imaging system.

FIG. 10 shows a similar device as a portable tablet or smart phone. A similar approach may be used for a desktop monitor or a wall display. The tablet or monitor 550 includes a display 552 and a bezel 554. The bezel is used to house the various audiovisual components of the device. In this example, the bottom part of the bezel below the display houses two microphones 556 and the top of the bezel above the display houses a speaker 558. This is a suitable configuration for a smart phone and may also be adapted for use with other types of devices. The bezel also houses two cameras for depth 564, 566 stacked, and one or more LEDs 560, 562 for illumination. The various processors and other components discussed above may be housed behind the display and bezel or in another connected component.

The particular placement and number of the components shown may be adapted to suit different usage models. More and fewer microphones, speakers, and LEDs may be used to suit different implementations. Additional components, such as proximity sensors, rangefinders, additional cameras, and other components may also be added to the bezel or to other locations, depending on the particular implementation.

The video conferencing or gaming nodes of FIGS. 9 and 10 are provided as examples, but different form factors such as a desktop workstation, a wall display, a conference room telephone, an all-in-one or convertible computer, and a set-top box form factor may be used, among others. The image sensors may be located in a separate housing from the display and may be disconnected from the display bezel, depending on the particular implementation. In some implementations, the display may not have a bezel. For such a display, the microphones, cameras, speakers, LEDs and other components may be mounted in other housing that may or may not be attached to the display.

In another embodiment, the cameras and microphones are mounted to a separate housing to provide a remote video device that receives both infrared and visible light images in a compact enclosure. Such a remote video device may be used for surveillance, monitoring, environmental studies and other applications, such as remotely controlling other devices such as television, lights, shades, ovens, thermostats, and other appliances. A communications interface may then transmit the captured infrared and visible light imagery to another location for recording and viewing.

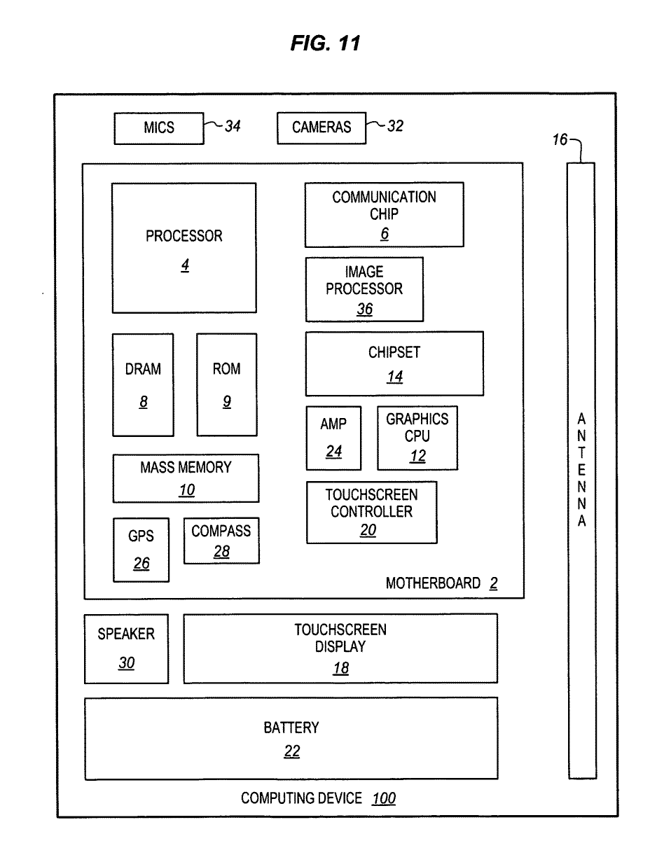

FIG. 11 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, cameras 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 including any depth sensors or proximity sensor are coupled to an optional image processor 36 to perform conversions, analysis, noise reduction, comparisons, depth or distance analysis, image understanding and other processes as described herein. The processor 4 is coupled to the image processor to drive the process with interrupts, set parameters, and control operations of image processor and the cameras. Image processing may instead be performed in the processor 4, the cameras 32 or in any other device.

In various implementations, the computing device 100 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes identifying a region of a row of pixel depth data in a row of pixels from a depth image, the depth image having a plurality of rows of pixels of an image from a first camera at a first camera position C1 and depth information for each pixel using a corresponding image from a second camera at a second camera position C2, un-projecting a first valid pixel on a first side of the identified region into a three-dimensional space to determine first point P1, determining a first vector from the position C2 of the second camera to the first point, un-projecting a second valid pixel on a second side of the identified region into a three-dimensional space to determine second point P2, determining a second vector from the position C2 of the second camera to the second point, determining, at the position of the second camera, an angle between the first vector and the second vector, comparing the angle to a threshold, and classifying the missing region as a shadow region if the angle is less than the threshold.

In further embodiments determining an angle comprises computing a dot product between the first vector and the second vector and wherein comparing the angle comprises comparing the dot product to the threshold.

In further embodiments include determining an angle comprises computing a dot product between the first vector and the second vector and taking the inverse cosine of the dot product and wherein comparing the angle comprises comparing the dot product to the threshold.

Further embodiments include determining the threshold using the pixels of the depth image using two valid adjacent pixels.

In further embodiments the first camera captures an image and the second camera is an infrared projector.

Further embodiments include comparing shadow classifications for other rows of the image near the row of pixel data to the row of pixel data, and classifying the missing region as not a shadow region if the missing region is not consistent with the other rows.

Some embodiments pertain to a computing system that includes a first camera to generate an image of objects in a scene, the image comprising a plurality of pixels, a depth imaging device to determine pixel depth data for pixels of the image, the depth data indicating a distance from the camera to a corresponding object represented by each respective pixel, and a processor to receive the image and the depth data and to identify a region of a row of pixel depth data in a row of pixels from the image, to un-project a first valid pixel on a first side of the identified region into a three-dimensional space to determine first point P1, to determine a first vector from the position C2 of the second camera to the first point, to un-project a second valid pixel on a second side of the identified region into a three-dimensional space to determine second point P2, to determine a second vector from the position C2 of the second camera to the second point, to determine, at the position of the second camera, an angle between the first vector and the second vector, to compare the angle to a threshold, and classify the missing region as a shadow region if the angle is less than the threshold.

Further embodiments include a command system to receive the classifying, the image and the pixel depth data as input.

Further embodiments include an image analysis system to fill in missing pixel depth data using the classifying.

In further embodiments the processor determines an angle by computing a dot product between the first vector and the second vector and compares the angle by comparing the dot product to the threshold.

In further embodiments the processor determines an angle by computing a dot product between the first vector and the second vector and taking the inverse cosine of the dot product and compares the angle by comparing the dot product to the threshold.

In further embodiments the processor further determines the threshold using the pixels of the depth image using two valid adjacent pixels.

In further embodiments the first camera captures an image and the depth imaging device is an infrared projector.

In further embodiments the processor is an image processor, the computer system further comprising a central processing unit coupled to the image processor.

In further embodiments the processor further compares shadow classifications for other rows of the image near the row of pixel data to the row of pixel data, and classifies the missing region as not a shadow region if the missing region is not consistent with the other rows.

Some embodiments pertain to a computer-readable medium having instructions thereon that when operated on by the computer causes the computer to perform operations that include identifying a region of a row of pixel depth data in a row of pixels from a depth image, the depth image having a plurality of rows of pixels of an image from a first camera at a first camera position C1 and depth information for each pixel using a corresponding image from a second camera at a second camera position C2, un-projecting a first valid pixel on a first side of the identified region into a three-dimensional space to determine first point P1, determining a first vector from the position C2 of the second camera to the first point, un-projecting a second valid pixel on a second side of the identified region into a three-dimensional space to determine second point P2, determining a second vector from the position C2 of the second camera to the second point, determining, at the position of the second camera, an angle between the first vector and the second vector, comparing the angle to a threshold, and classifying the missing region as a shadow region if the angle is less than the threshold.

In further embodiments determining an angle comprises computing a dot product between the first vector and the second vector and wherein comparing the angle comprises comparing the dot product to the threshold.

In further embodiments determining an angle comprises computing a dot product between the first vector and the second vector and taking the inverse cosine of the dot product and wherein comparing the angle comprises comparing the dot product to the threshold.

Further embodiments include determining the threshold using the pixels of the depth image using two valid adjacent pixels.

Further embodiments include comparing shadow classifications for other rows of the image near the row of pixel data to the row of pixel data, and classifying the missing region as not a shadow region if the missing region is not consistent with the other rows.

What is claimed is:

1. A method comprising:
identifying a region of a row of pixel depth data in a row of pixels from a depth image, the depth image having a plurality of rows of pixels of an image from a first camera at a first camera position C1 and depth information for each pixel using a corresponding image from a second camera at a second camera position C2;
un-projecting a first valid pixel on a first side of the identified region into a three-dimensional space to determine first point P1;
determining a first vector from the position C2 of the second camera to the first point;
un-projecting a second valid pixel on a second side of the identified region into a three-dimensional space to determine second point P2;
determining a second vector from the position C2 of the second camera to the second point;
determining, at the position of the second camera, an angle between the first vector and the second vector;
comparing the angle to a threshold; and
classifying the missing region as a shadow region if the angle is less than the threshold.

2. The method of claim 1, wherein determining an angle comprises computing a dot product between the first vector and the second vector and wherein comparing the angle comprises comparing the dot product to the threshold.

3. The method of claim 1, wherein determining an angle comprises computing a dot product between the first vector and the second vector and taking the inverse cosine of the dot product and wherein comparing the angle comprises comparing the dot product to the threshold.

4. The method of claim 1, further comprising determining the threshold using the pixels of the depth image using two valid adjacent pixels.

5. The method of claim 1, wherein the first camera captures an image and the second camera is an infrared projector.

6. The method of claim 1, further comprising:
comparing shadow classifications for other rows of the image near the row of pixel data to the row of pixel data; and
classifying the missing region as not a shadow region if the missing region is not consistent with the other rows.

7. A computer system comprising:
a first camera to generate an image of objects in a scene, the image comprising a plurality of pixels;
a depth imaging device to determine pixel depth data for pixels of the image, the depth data indicating a distance from the camera to a corresponding object represented by each respective pixel; and
a processor to receive the image and the depth data and to identify a region of a row of pixel depth data in a row of pixels from the image, to un-project a first valid pixel on a first side of the identified region into a three-dimensional space to determine first point P1, to determine a first vector from the position C2 of the second camera to the first point, to un-project a second valid pixel on a second side of the identified region into a three-dimensional space to determine second point P2, to determine a second vector from the position C2 of the second camera to the second point, to determine, at the position of the second camera, an angle between the first vector and the second vector, to compare the angle to a threshold, and classify the missing region as a shadow region if the angle is less than the threshold.

8. The computer system of claim 7 further comprising a command system to receive the classifying, the image and the pixel depth data as input.

9. The computer system of claim 8, further comprising an image analysis system to fill in missing pixel depth data using the classifying.

10. The computer system of claim 7, wherein the processor determines an angle by computing a dot product between the first vector and the second vector and compares the angle by comparing the dot product to the threshold.

11. The computer system of claim 7, wherein the processor determines an angle by computing a dot product between the first vector and the second vector and taking the inverse cosine of the dot product and compares the angle by comparing the dot product to the threshold.

12. The computer system of claim 7, wherein the processor further determines the threshold using the pixels of the depth image using two valid adjacent pixels.

13. The computer system of claim 1, wherein the first camera captures an image and the depth imaging device is an infrared projector.

14. The computer system of claim 7, wherein the processor is an image processor, the computer system further comprising a central processing unit coupled to the image processor.

15. The computer system of claim 1, wherein the processor further compares shadow classifications for other rows of the image near the row of pixel data to the row of pixel data, and classifies the missing region as not a shadow region if the missing region is not consistent with the other rows.

16. A non-transitory computer-readable medium having instructions thereon that when operated on by the computer causes the computer to perform operations comprising;
identifying a region of a row of pixel depth data in a row of pixels from a depth image, the depth image having a plurality of rows of pixels of an image from a first camera at a first camera position C1 and depth information for each pixel using a corresponding image from a second camera at a second camera position C2;
un-projecting a first valid pixel on a first side of the identified region into a three-dimensional space to determine first point P1;
determining a first vector from the position C2 of the second camera to the first point;
un-projecting a second valid pixel on a second side of the identified region into a three-dimensional space to determine second point P2;
determining a second vector from the position C2 of the second camera to the second point;
determining, at the position of the second camera, an angle between the first vector and the second vector;
comparing the angle to a threshold; and
classifying the missing region as a shadow region if the angle is less than the threshold.

17. The medium of claim 16, wherein determining an angle comprises computing a dot product between the first vector and the second vector and wherein comparing the angle comprises comparing the dot product to the threshold.

18. The medium of claim 16, wherein determining an angle comprises computing a dot product between the first vector and the second vector and taking the inverse cosine of the dot product and wherein comparing the angle comprises comparing the dot product to the threshold.

19. The medium of claim 16, the operations further comprising determining the threshold using the pixels of the depth image using two valid adjacent pixels.

20. The medium of claim 16, the operations further comprising:
comparing shadow classifications for other rows of the image near the row of pixel data to the row of pixel data; and
classifying the missing region as not a shadow region if the missing region is not consistent with the other rows.
